(19) United States
(12) Patent Application Publication
(10) Pub. No.: US 2011/0133365 A1
(43) Pub. Date: Jun. 9, 2011

(54) Film substrate processing method and film substrate processing aparatus

(75) Inventors: Akihiko Ushimaru, Kawasaki (JP); Yoshiaki Yanagida, Kawasaki (JP); Fumihiko Tokura, Kawasaki (JP)

(73) Assignee: Fujitsu Limited, Kawasaki (JP)

(21) Appl. No.: 12/929,573

(22) Filed: Feb. 1, 2011

Related U.S. Application Data
(63) Continuation of application No. PCT/JP2008/064244, filed on Aug. 7, 2008.

(51) Int. Cl. B29C 35/08; B29C 37/02

(52) U.S. Cl. 264/400; 264/161; 425/404; 425/174.4

(57) ABSTRACT

A method of processing a film substrate includes removing a portion of the film substrate; and fusing a part of the film substrate around the removed portion to seal scraps of the film substrate, which are generated when removing the portion of the film substrate, in the fused part of the film substrate.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2008/064244 filed on Aug. 7, 2008, the entire contents of which are incorporated herein by reference.

### FIELD

The embodiments discussed herein are related to a film substrate processing method and a film substrate processing apparatus.

### BACKGROUND

For example, in a process of manufacturing a product from a flexible film substrate, holes such as sprocket holes (through holes) used to move or feed the film substrate are formed in the film substrate. In another example, when manufacturing multiple products from one film substrate, holes defining outlines of the respective products are formed in the film substrate. Such holes are generally formed by die punching or by using a laser beam.

FIGS. 1A and 1B illustrate a punching device 1 for forming a hole 16 in a film substrate. FIG. 1A illustrates a process of forming the hole 16 in a single-layer film substrate 10, and FIG. 1B illustrates a process of forming the hole 16 in a two-layer film substrate 11.

The punching device 1 includes a punching table 3 on which the film substrate 10/11 is placed, a brace 4 for holding the film substrate 10/11 on the punching table 3, and a punching die 2 for forming the hole 16 in the film substrate 10/11. The punching die 2 is movable upward and downward in FIGS. 1A and 1B. A punching hole through which the punching die 2 moves is formed in the punching table 3. With the film substrate 10/11 placed on the punching table 3 and held by the brace 4, the punching die 2 is moved downward to form the hole 16 in the film substrate 10/11.

In another method, a hole is formed by illuminating a predetermined portion of a film substrate with a focused laser beam and thereby vaporizing the portion of the film substrate (see, for example, Japanese Laid-Open Patent Publication No. 07-022472).

However, when the film substrate 10/11 is made of resin with high viscosity, it is difficult to uniformly cut (press-cut, shear, or punch) the film substrate 10/11 with the punching device 1 including the punching table 3 and as a result, burrs and fragments are formed around the hole 16 (particularly in areas A1 and A2 indicated by dashed-dotted lines in FIGS. 1A and 1B). Also, when the film substrate 10/11 has a multi-layer structure including, for example, a conducting layer, a coating layer, and a protective layer with different degrees of hardness and viscosity, it is difficult to uniformly cut (press-cut, shear, or punch) the film substrate 10/11 with the punching device 1. Thus, in a removing process (i.e., a process for removing or cutting (shearing) a portion of a film substrate) using the punching device 1, burrs and fragments (hereafter called “scraps”) are necessarily generated.

With a removing process using a laser beam, since high thermal energy is applied to a small portion of a film substrate to vaporize the portion, particles and fragments (hereafter also called “scraps”) of the film substrate are scattered or adhere to the processed surface of the film substrate (see, for example, Japanese Laid-Open Patent Publication No. 07-022472). Also, since a film substrate tends to be carbonized when illuminated by a laser beam and the absorptance of a film substrate varies depending on its components, it is difficult to form a uniform processed surface and scraps tend to remain on the processed surface.

Such scraps remaining around the removed portion of the film substrate 10/11 may fall off or be scattered in a process performed after the removing process. For example, if a hole is formed in a film substrate including a conducting layer and to be used for a thin flexible display device by one of the above described methods, scraps of the film substrate may fall off or be scattered and cause a short circuit between conductive patterns. Also, if the scraps enter a display area of the thin flexible display device, a display error may occur.

In the related art, to prevent the above problems, scraps (burrs and fragments) adhering to a film substrate after a removing process are removed by washing or wet etching (see, for example, Japanese Laid-Open Patent Publication No. 07-022472).

### SUMMARY

According to an aspect of the invention, there is provided a method of processing a film substrate. The method includes removing a portion of the film substrate; and fusing a part of the film substrate around the removed portion to seal scraps of the film substrate, which are generated when removing the portion of the film substrate, in the fused part of the film substrate.

The object and advantages of the invention will be realized and attained by means of the elements and combinations particularly pointed out in the claims.

It is to be understood that both the foregoing generation description and the followed detailed description are exemplary and explanatory and are not restrictive of the invention, as claimed.

### BRIEF DESCRIPTION OF DRAWINGS

FIG. 1A is a diagram illustrating a process of forming a hole in a single-layer film substrate;

FIG. 1B is a diagram illustrating a process of forming a hole in a two-layer film substrate;

FIG. 2A is a diagram illustrating a method of processing a film substrate according to an embodiment of the present invention;

FIG. 2B is an enlarged view of a portion around a hole formed in the film substrate illustrated in FIG. 2A;

FIG. 3A is a diagram illustrating a method of processing a film substrate according to another embodiment of the present invention;

FIG. 3B is an enlarged view of a portion around a hole formed in the film substrate illustrated in FIG. 3A;

FIG. 4A is a diagram illustrating a two-layer film substrate, which includes a low-melting point layer as an upper layer and a high-melting point layer as a lower layer, being illuminated by a laser beam;

FIG. 4B is a diagram illustrating scraps sealed in a two-layer film substrate including a low-melting point layer as an upper layer and a high-melting point layer as a lower layer;

FIG. 5A is a diagram illustrating a two-layer film substrate, which includes a high-melting point layer as an upper layer and a low-melting point layer as a lower layer, being illuminated by a laser beam;

FIG. 5B is a diagram illustrating scraps sealed in a two-layer film substrate including a high-melting point layer as an upper layer and a low-melting point layer as a lower layer;

FIG. 6 is a diagram illustrating an exemplary configuration of a film substrate processing apparatus according to an embodiment of the present invention;

FIG. 7 is a diagram illustrating an exemplary control system of a film substrate processing apparatus according to an embodiment of the present invention;

FIG. 8 is a flowchart for describing an exemplary process performed by a film substrate processing apparatus according to an embodiment of the present invention;

FIG. 9 is a diagram illustrating a variation of the film substrate processing apparatus of FIG. 6; and

FIG. 10 is a diagram illustrating a control system of the variation of the film substrate processing apparatus illustrated in FIG. 9.

### DESCRIPTION OF EMBODIMENTS

As described above, in the related art, scraps (burrs and fragments) adhering to a film substrate after a removing process are removed by washing or wet etching. However, with a washing or wet etching method where the film substrate is soaked in a cleaning liquid or an etching liquid, there is a risk that the film substrate is stained or a conductive layer or a coating layer of the film substrate is deteriorated by the cleaning liquid or the etching liquid. Embodiments of the present invention make it possible to prevent this problem while reliably preventing scraps generated around a removed portion of a film substrate from falling off or being scattered.

Preferred embodiments of the present invention will be described with reference to the accompanying drawings.

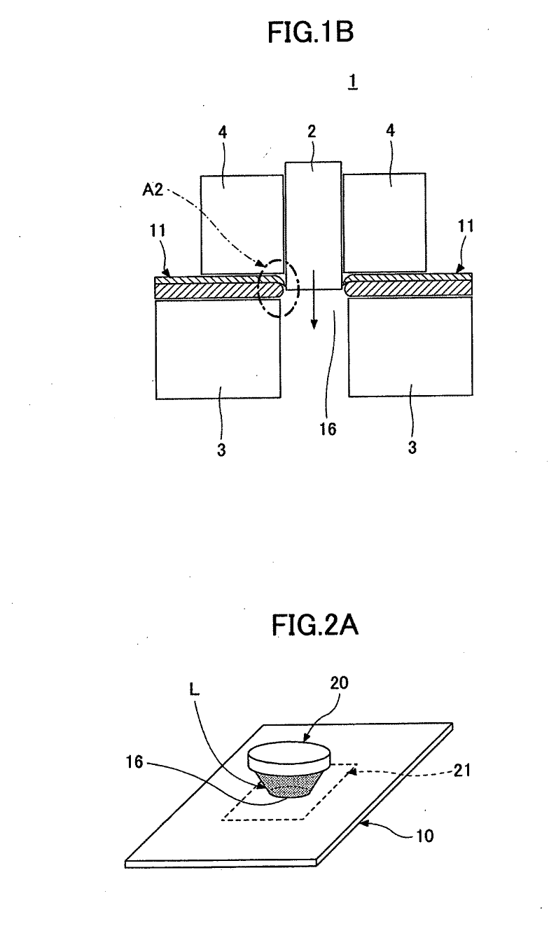

Film substrate processing methods according to embodiments of the present invention are described below with reference to FIGS. 2A through 5B. In the embodiments described below, it is assumed that a flexible film substrate made of resin such as polycarbonate is to be processed.

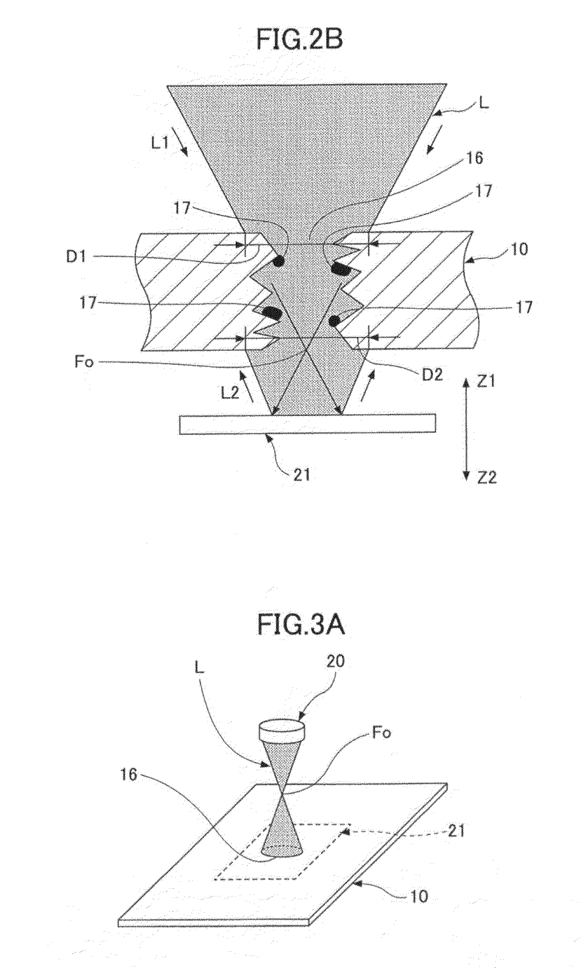

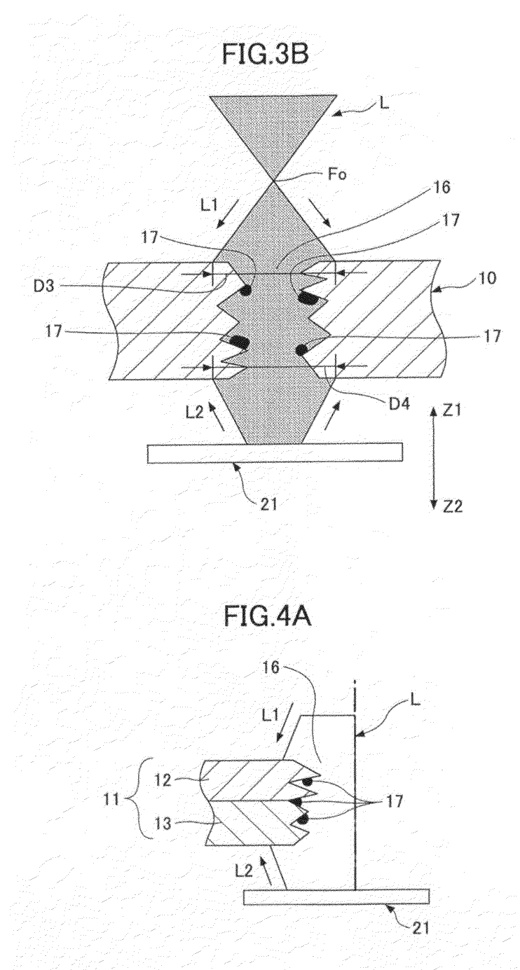

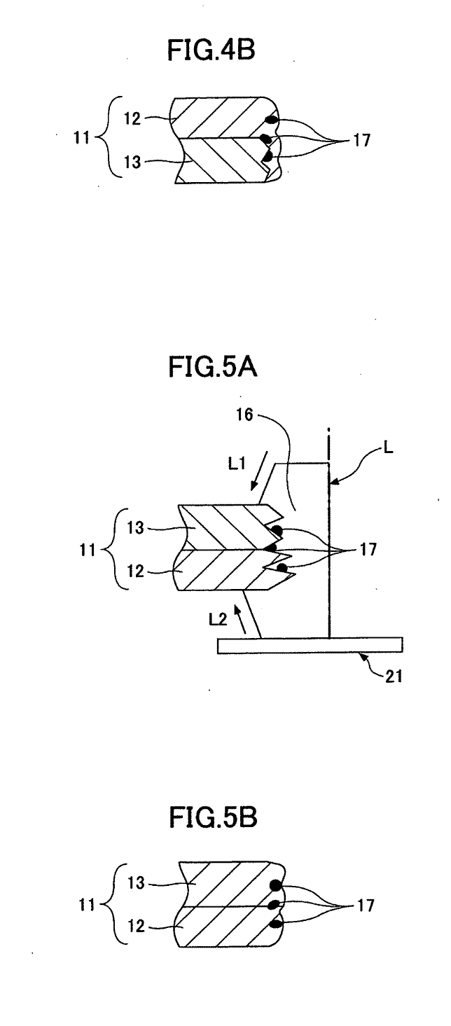

A single-layer film substrate 10 is used in FIGS. 2A, 2B, 3A, and 3B; and a two-layer film substrate 11 including a low-melting point layer 12 and a high-melting point layer 13 is used in FIGS. 4A, 4B, 5A, and 5B. The embodiments of the present invention may be applied to any appropriate type of film substrate. For example, the embodiments of the present invention may be applied to a multi-layer film including polycarbonate and indium oxide.

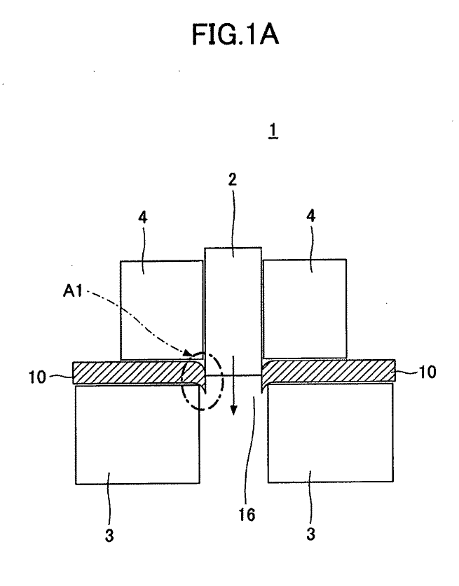

According to an embodiment, a film substrate processing method includes a removing step and a fusing step. In this embodiment, the film substrate 10 is used to describe the film substrate processing method. In the removing step, a predetermined portion of the film substrate 10 is removed to form a hole 16. The hole 16 may be formed, for example, by using the punching device 1 described with reference to FIGS. 1A and 1B or by using a laser beam. As a result of the removing step, as described above, scraps 17 (burrs and fragments) remain around the removed portion (the hole 16) of the film substrate 10.

FIGS. 2B and 33 are enlarged views of a portion around the hole 16 formed in the film substrate 10. As shown in FIGS. 2B and 3B, the hole 16 has a rough and complex inner surface having protrusions and grooves. The scraps 17 adhere to the protrusions and grooves.

In this embodiment, the removing step indicates a step of forming the hole 16 in the film substrate 10. However, the removing step may indicate any other step of processing a film substrate (e.g., cutting, press-cutting, or shearing a film substrate or forming a groove in a film substrate) where scraps of the film substrate are generated.

After the removing step, the fusing step is performed. In the fusing step, a part of the film substrate 10 around the hole 16 (i.e., the removed portion) is fused (melted by heating) to seal the scraps 17 in the fused film substrate 10. In this embodiment, a laser beam is used to fuse the part of the film substrate 10 around the hole 16.

A basic concept underlying the method of processing the scraps 17 in this embodiment is described below. The scraps 17 (e.g., burrs and fragments) are originally parts of the film substrate 10. Therefore, as long as the scraps 17 are on the inner surface of the hole 16 without falling off or being scattered, it may not be necessary to remove the scraps 17 to prevent problems such as a short circuit between conductive patterns and a display error.

For this reason, in this embodiment, instead of removing the scraps 17 from the film substrate 10, the scraps 17 are sealed in the film substrate 10 so as not to fall off or be scattered. More specifically, a part of the film substrate 10 around the hole 16, where the scraps 17 are present, is fused so that the scraps 17 are sealed (or trapped) in the fused part of the film substrate 10. This method makes it possible to reliably prevent the scraps 17 from falling off or being scattered.

The temperature for fusing the film substrate 10 is preferably controlled based on the size(s) of the scraps 17 (burrs and fragments) and/or the melting point of the film substrate 10. With a laser beam, the temperature for fusing the film substrate 10 can be easily controlled. Therefore, a laser beam is preferably used to fuse the film substrate 10. While a high-energy laser beam is used to cut or remove a portion of the film substrate 10 (i.e., to form the hole 16 in the removing step), a laser beam with comparatively low energy may be used to fuse the film substrate 10 in the fusing step.

Although a laser beam is preferably used for the fusing step of this embodiment, any other means may be used to fuse the film substrate 10. For example, heated air or an electron beam may be used to fuse the film substrate 10 in the fusing step.

An exemplary fusing step using a laser beam is described below.

In FIGS. 2A and 2B, a part of the film substrate 10 around the hole 16 is fused using a laser beam L. In this example, it is assumed that a laser unit (not shown) is disposed to face the front surface (upper surface or top surface) of the film substrate 10. The laser beam L emitted from the laser unit is focused by a condenser lens 20 to illuminate a part of the film substrate 10 around the hole 16. The part of the film substrate 10 around the hole 16 may include the front and back surfaces of the film substrate 10 around the hole 16 (or the removed portion) and the inner surface of the hole 16. The front surface of the film substrate 10 around the hole 16 is illuminated directly by the laser beam L emitted from the laser unit. Therefore, the laser beam L illuminating the front surface of the film substrate 10 around the hole 16 is called a direct beam L1.

A reflecting plate 21 is disposed to face the back surface (lower surface or bottom surface) of the film substrate 10. The reflecting plate 21 is, for example, a metal plate made of copper and has a mirror-finished surface. As illustrated in FIG. 2B, the laser beam L from the laser unit passes through the hole 16, is reflected by the reflecting plate 21, and then illuminates the back surface of the film substrate 10 around the hole 16. The reflected laser beam L illuminating the back surface of the film substrate 10 around the hole 16 is called a reflected beam L2. Here, the terms “front surface” and “back surface” are merely used to distinguish two surfaces of the film substrate 10 and the two surfaces of the film substrate 10 (or 11) may be called first and second surfaces.

Thus, in this embodiment, the reflecting plate 21 is disposed to face the back surface of the film substrate 10. With this configuration, the front surface of the film substrate 10 (around the hole 16) is illuminated by the direct beam L1 and the back surface of the film substrate 10 (around the hole 16) is illuminated by the reflected beam L2. Accordingly, the part of the film substrate 10 around the hole 16 is heated and fused both from the front surface and the back surface and as a result, the scraps 17 are enclosed (or sealed) in the fused part of the film substrate 10. This configuration makes it possible to effectively prevent the scraps 17 from falling off or being scattered.

The condenser lens 20 and the reflecting plate 21 are preferably configured to be movable upward and downward with respect to the film substrate 10. This configuration makes it possible to adjust the distance between the film substrate 10 and the condenser lens 20 and the distance between the film substrate 10 and the reflecting plate 21, and thereby makes it possible to control illumination conditions (or parameters) of the direct beam L1 and the reflected beam L2 on the film substrate 10.

In this embodiment, the illumination conditions indicate the diameters of spots (spot diameters) formed on the film substrate 10 by the direct beam L1 and the reflected beam L2. A spot diameter D1 of the direct beam L1 on the front surface of the film substrate 10 can be adjusted by moving the condenser lens 20 with respect to the film substrate 10 and thereby adjusting the distance between the film substrate 10 and the condenser lens 20. Similarly, a spot diameter D2 of the reflected beam L1 on the back surface of the film substrate 10 can be adjusted by moving the reflecting plate 21 with respect to the film substrate 10 and thereby adjusting the distance between the film substrate 10 and the reflecting plate 21.

More specifically, in this embodiment, the distance between the film substrate 10 and the condenser lens 20 and the distance between the film substrate 10 and the reflecting plate 21 are adjusted such that the spot diameter D1 equals the spot diameter D2 (D1=D2). Adjusting the spot diameter D1 and the spot diameter D2 to become equal to each other makes it possible to equally heat the front and back surfaces of the film substrate 10 at the same time. This configuration makes it possible to more reliably enclose (or seal) the scraps 17 in the fused part of the film substrate 10 and thereby makes it possible to more effectively prevent the scraps 17 from falling off or being scattered.

When the condenser lens 20 is configured to be movable with respect to the film substrate 10, the focal point (Fo) of the condenser lens 20 may be set at the back surface side of the film substrate 10 (i.e., at or below the back surface of the film substrate 10) or at the front surface side of the film substrate 10 (i.e., above the front surface of the film substrate 10). In FIGS. 2A and 2B, the focal point Fo of the condenser lens 20 is at the back surface side of the film substrate 10; in FIGS. 3A and 3B, the focal point Fo of the condenser lens 20 is at the front surface side of the film substrate 10. The fusing step can be performed properly in either one of the two cases.

When the focal point Fo is at the back surface side of the film substrate 10 as illustrated in FIGS. 2A and 2B, the front surface of the film substrate 10 is illuminated by the direct beam L1 before the laser beam L is focused by the condenser lens 20. In this case, the distance between the condenser lens 20 and the film substrate 10 is adjusted such that the entire periphery of the hole 16 is illuminated by the direct beam L1. Also in this case, a part of the laser beam L passing through the hole 16 is focused at the focal point Fo and then diverges and enters the reflecting plate 21. The entered laser beam L is reflected by the reflecting plate 21 as the reflected beam L2. The distance between the reflecting plate 21 and the film substrate 10 is adjusted such that the spot diameter D2 of the reflected beam L2 on the back surface of the film substrate 10 becomes equal to the spot diameter D1 of the direct beam L1.

When the focal point Fo is at the front surface side of the film substrate 10 as illustrated in FIGS. 3A and 3B, the laser beam L is focused at the focal point Fo by the condenser lens 20 and diverges and enters the front surface of the film substrate 10. In this case, the distance between the condenser lens 20 and the film substrate 10 is adjusted such that the entire periphery of the hole 16 is illuminated by the direct beam L1. A part of the laser beam L passing through the hole 16 diverges and enters the reflecting plate 21. The entered laser beam L is reflected by the reflecting plate 21 as the reflected beam L2. The distance between the reflecting plate 21 and the film substrate 10 is adjusted such that a spot diameter D4 of the reflected beam L2 on the back surface of the film substrate 10 becomes equal to a spot diameter D3 of the direct beam L1.

Preferably, the laser beam L is also controlled based on the configuration of a film substrate. An exemplary fusing step for the two-layer film substrate 11 according to an embodiment of the present invention is described below with reference to FIGS. 4A and 4B. As illustrated in FIGS. 4A and 4B, the two-layer film substrate 11 includes the low-melting point layer 12 as an upper layer and the high-melting point layer 13 as a lower layer.

In the fusing step of this embodiment, the energy of the direct beam L1 illuminating the low-melting point layer 12 is controlled by adjusting the distance between the film substrate 11 and the condenser lens 20 such that the direct beam L1 achieves a temperature that is sufficient to fuse the low-melting point layer 12. In this case, it is not necessary to fuse the high-melting point layer 13 with the reflected beam L2 and therefore the reflecting plate 21 may be omitted.

With this configuration, as illustrated in FIG. 4B, the low-melting point layer 12 is fused by the laser beam L (the direct beam L1) and the scraps 17 are sealed in the fused low-melting point layer 12. Also, the fused low-melting point layer 12 flows to cover (the processed surface of) the high-melting point layer 13. Thus, this configuration makes it possible to reliably seal the scraps 17 in the low-melting point layer 12.

Also, since the two-layer film material 11 is heated at a temperature that is sufficient to fuse the low-melting point layer 12 and it is not necessary to increase the temperature to the melting point of the high-melting point layer 13, this configuration makes it possible to reduce the damage to the low-melting point material layer 12. Further, this configuration makes it possible to reduce the output level of the laser beam L and thereby makes it possible to reduce the running cost.

Another exemplary fusing step for the two-layer film substrate 11 according to an embodiment of the present invention is described below with reference to FIGS. 5A and 5B. In this embodiment, as illustrated in FIGS. 5A and 5B, the two-layer film substrate 11 includes the high-melting point layer 13 as an upper layer and the low-melting point layer 12 as a lower layer.

In the fusing step of this embodiment, the energy of the direct beam L1 illuminating the high-melting point layer 13 is controlled by adjusting the distance between the film substrate 11 and the condenser lens 20 such that the direct beam L1 achieves a temperature that is sufficient to fuse the high-melting point layer 13. In this case, if the low-melting point layer 12 is illuminated by the reflected beam L2 with energy as high as that of the direct beam L1, the low-melting point layer 12 may be damaged. Therefore, the distance between the reflecting plate 21 and the film substrate 11 is adjusted to reduce the energy of the reflected beam L2 (i.e., to increase the spot diameter of the reflected beam L2).

With this configuration, as illustrated in FIG. 5B, the low-melting point layer 12 and the high-melting point layer 13 are fused, respectively, at the optimum temperatures, and the scraps 17 are sealed in the fused low-melting point layer 12 and the fused high-melting point layer 13. Thus, this configuration makes it possible to reliably seal the scraps 17 in the two-layer film substrate 11.

The temperature for fusing the film substrate 10/11 may also be adjusted based on the size(s) of the scraps 17 (burrs and fragments) and/or the shape of the hole 16 by changing, for example, the laser output level, the target distance, the spot diameter, the illumination time, and/or the scanning rate.

Film substrate processing apparatuses according to embodiments of the present invention are described below.

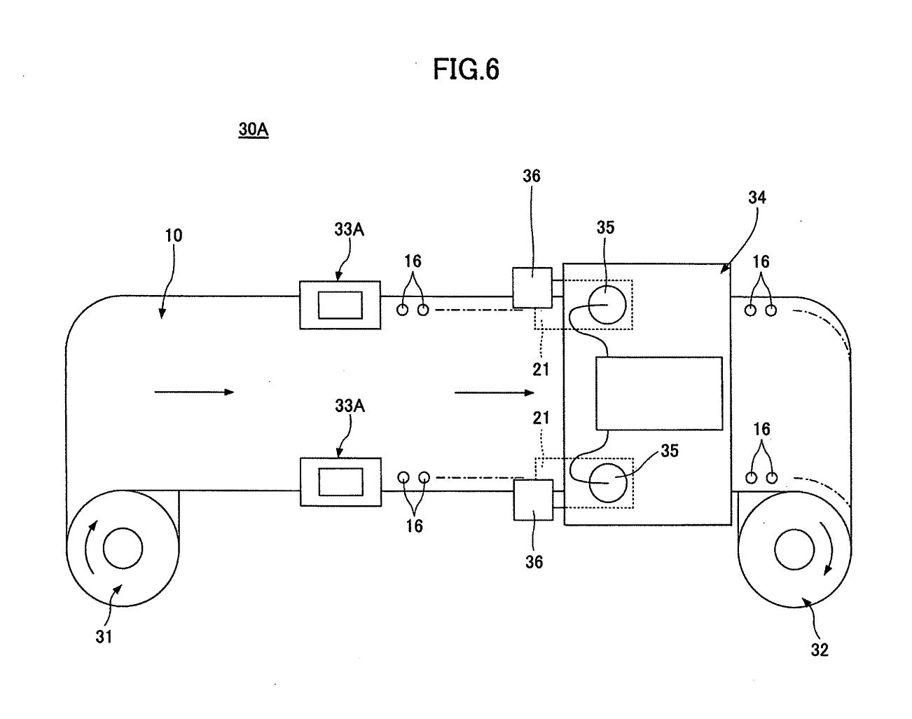

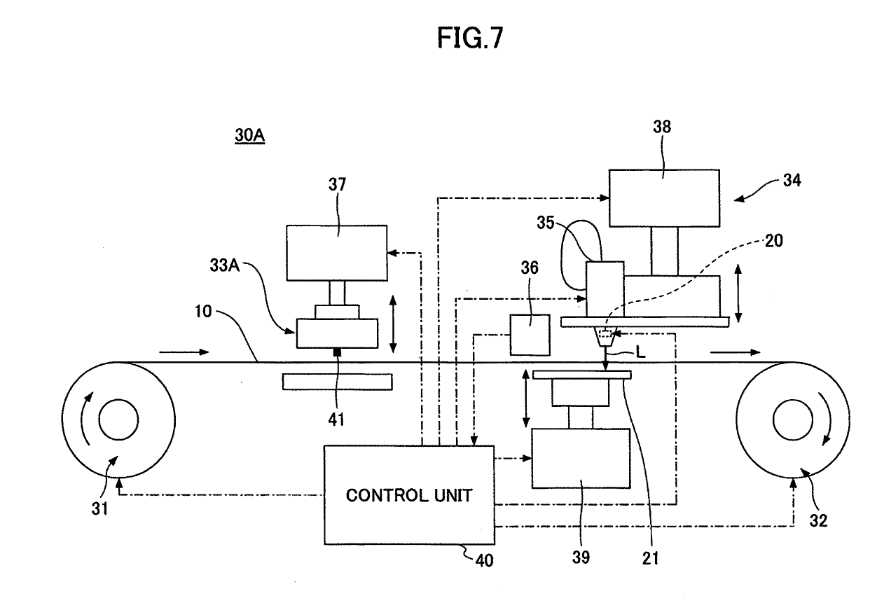

FIG. 6 is a diagram illustrating an exemplary configuration of a film substrate processing apparatus 30A according to an embodiment of the present invention, and FIG. 7 is a diagram illustrating an exemplary control system of the film substrate processing apparatus 30A.

The same reference numbers as those in FIGS. 1A through 5B are assigned to the corresponding components in FIGS. 6 and 7, In this embodiment, it is assumed that the film substrate processing apparatus 30A is used to manufacture an electronic paper. Also in this embodiment, it is assumed that the film substrate 10 is a multi-layer film including polycarbonate and indium oxide.

The film substrate processing apparatus 30A includes a supplying unit 31, a winding unit 32, punching units 33A (removing units), a heating unit 34, and height sensors 36. Below, multiple components of the same type (or function) may be expressed in the singular form for descriptive purposes. The supplying unit 31 and the winding unit 32 collectively function as a feeding unit for feeding the film substrate 10 (the feeding direction of the film substrate 10 is indicated by arrows in FIGS. 6 and 7). Before holes 16 are formed, the film substrate 10 is wound around the supplying unit 31. A removing step for forming the holes 16 and a fusing step for sealing the scraps 17 are performed while the film substrate 10 is fed from the supplying unit 31 and wound around the winding unit 32.

The punching units 33A are disposed above the corresponding edges (in the width direction) of the film substrate 10 in the feeding path of the film substrate 10. Each of the punching units 33A has a configuration similar to that of the punching device 1 illustrated by FIG. 1A. As illustrated in FIG. 7, the punching unit 33A includes a punching die 41 and a lifting-and-lowering unit 37 for moving the punching die 41 upward and downward. When the punching die 41 is moved downward by the lifting-and-lowering unit 37, the punching die 41 pierces the film substrate 10 and as a result, the hole 16 is formed in the film substrate 10. In this embodiment, the punching unit 33A includes one punching die 41 and is therefore configured to form one hole 16 at a time (single-hole punch). As described above, when the hole 16 is formed, the scraps 17 are generated and adhere to the inner surface of the hole 16.

The heating unit 34 is disposed downstream of the punching units 33A in the feeding direction of the film substrate 10. The heating unit 34 includes reflecting plates 21, laser units 35, lifting-and-lowering units 38, and lifting-and-lowering units 39.

Each of the laser units 35 is disposed to face the hole(s) 16 formed in the film substrate 10 being fed. The laser unit 35 emits a laser beam L to illuminate a part of the film substrate 10 around the hole 16 (or the removed portion). The part of the film substrate 10 around the hole 16 is fused by the laser beam L to seal the scraps 17 adhering to the inner surface of the hole 16 in the film substrate 10.

A condenser lens 20 is disposed within the laser unit 35 near the tip of the laser unit 35 facing the film substrate 10. The laser unit 35 can be moved upward and downward by the lifting-and-lowering unit 38. When the laser unit 35 is moved downward by the lifting-and-lowering unit 38, the distance between the film substrate 10 and the condenser lens 20 is reduced. On the other hand, when the laser unit 35 is moved upward by the lifting-and-lowering unit 38, the distance between the film substrate 10 and the condenser lens 20 is increased.

The reflecting plates 21 are disposed at the back surface side of the film substrate 10 so as to face the corresponding laser emitting positions of the laser units 35. Each of the reflecting plates 21 is a metal plate (e.g., a copper plate) with a mirror-finished surface facing the film substrate 10. The reflecting plate 21 can be moved upward and downward by the lifting-and-lowering unit 39.

When the reflecting plate 21 is moved upward by the lifting-and-lowering unit 39, the distance between the film substrate 10 and the reflecting plate 21 is reduced. On the other hand, when the reflecting plate 21 is moved downward by the lifting-and-lowering unit 39, the distance between the film substrate 10 and the reflecting plate 21 is increased.

The height sensors 36 are disposed between the punching units 33A and the heating unit 34 above the corresponding edges of the film substrate 10 in the feeding path of the film substrate 10. The height sensor 36 detects a change in the height of the film substrate 10 from a reference position.

When the hole 16 is formed using the punching die 41, the film substrate 10 may sometimes be warped (or distorted). Such a warp may results in a change or an error (height error) in the height of the film substrate 10 and makes it difficult to accurately adjust the distance between the film substrate 10 and the condenser lens 20 of the heating unit 34 and to properly control the temperature for heating the film substrate 10. In this embodiment, to prevent this problem, the height error of the film substrate 10 is calculated based on the detection result of the height sensor 36 and the heights of the condenser lens 20 and the reflecting plate 21 are adjusted based on the height error. This configuration makes it possible to more accurately control the temperature for heating the film substrate 10.

The supplying unit 31, the winding unit 32, the laser units 35, the height sensors 36, and the lifting-and-lowering units 37-39 are connected to a control unit 40. The control unit 40 controls the film substrate processing apparatus 30A.

For example, the control unit 40 controls the supplying unit 31 and the winding unit 32 to feed the film substrate 10 at predetermined intervals (step feeding). The control unit 40 also controls the lifting-and-lowering unit 37 to form the holes 16 at predetermined intervals. Also, the control unit 40 controls the output level of the laser unit 35 based on the materials and/or the configuration of the film substrate 10 that are input in advance. Further, the control unit 40 calculates the height error of the film substrate 10 based on a detection signal from the height sensor 36 and controls the lifting-and-lowering units 38 and 39 based on the height error to adjust the temperature for heating the part of the film substrate 10 around the hole 16.

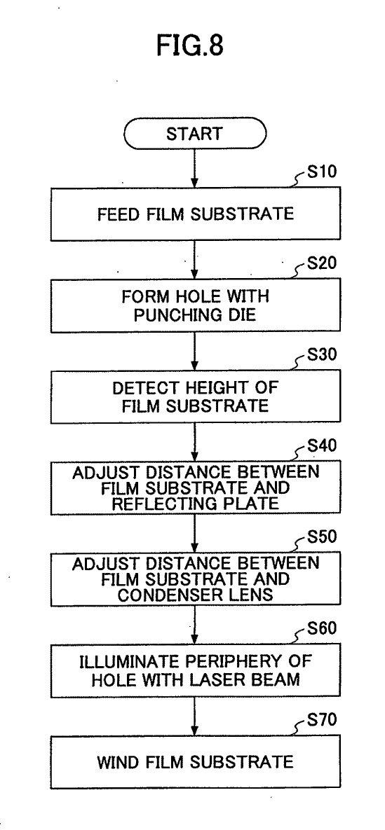

Next, operations of the film substrate processing apparatus 30A are described. FIG. 8 is a flowchart for describing an exemplary process performed on the film substrate 10 by the control unit 40 of the film substrate processing apparatus 30A.

When the process is started, the control unit 40 drives the supplying unit 31 and the winding unit 32 in step (S) 10 and thereby feeds a predetermined amount of the film substrate 10 from the supplying unit 31 toward the winding unit 32. In this embodiment, the punching unit 33A includes one punching die 41 and therefore the control unit 40 feeds an amount of the film substrate 10 that corresponds to the pitch between the holes 16.

In step 20, the control unit 40 drives the lifting-and-lowering unit 37 of the punching unit 33A to form the hole 16 in the film substrate 10 with the punching die 41. During this removing step (hole forming step), the supplying unit 31 and the winding unit 32 are temporarily stopped and accordingly, the film substrate 10 is not fed.

Meanwhile, when the film substrate 10 is fed in step 10, the hole 16 that has already been formed in the film substrate 10 by the punching unit 33A is moved toward the heating unit 34. In step 30, the height sensor 36 detects a change in the height of the film substrate 10 being fed toward the heating unit 34 and outputs a height error signal indicating the detection result to the control unit 40.

The control unit 40 calculates an optimum distance between the condenser lens 20 and the film substrate 10 and an optimum distance between the reflecting plate 21 and the film substrate 10 based on the height error signal from the height sensor 36 and pre-stored information on the materials and/or configuration of the film substrate 10 such that an optimum temperature for heating the part of the film substrate 10 around the hole 16 is achieved. The control unit 40 may also calculate an output level, a spot diameter, and illumination time of the laser beam L to be emitted by the laser unit 35 that are suitable for fusing the film substrate 10 and sealing the scraps 17.

In step 40, the control unit 40 drives the lifting-and-lowering unit 39 and thereby adjusts the distance between the film substrate 10 and the reflecting plate 21 to match the calculated optimum distance. In step 50, the control unit 50 drives the lifting-and-lowering unit 38 and thereby adjusts the distance between the film substrate 10 and the condenser lens 20 to match the calculated optimum distance.

When the feeding of the film substrate 10 is stopped, the hole 16 that has passed through the height sensor 36 is stopped at a position facing the laser unit 35. Accordingly, after the distance between the film substrate 10 and the condenser lens 20 and the distance between the film substrate 10 and the reflecting plate 21 are adjusted, the control unit 40, in step 60, causes the laser unit 35 to illuminate the part of the film substrate 10 around the hole 16 with the laser beam L. In this embodiment, since the punching unit 33A can form one hole 16 at a time, the laser beam L is emitted each time when the film substrate 10 is stopped. As a result, the scraps 17 on the inner surface of the hole 16 are sealed in the fused film substrate 10.

After the scraps 17 are sealed, the control unit 40, in step 70, drives the supplying unit 31 and the winding unit 32 again to feed (or wind) an amount of the film substrate 10 that corresponds to the pitch between the holes 16. The control unit 40 repeats steps 10 through 70 for the rest of the film substrate 10.

Thus, in processing the film substrate 10, the control unit 40 varies the laser output level, the target distance, the spot diameter, and/or the illumination time and thereby controls the temperature for fusing the film substrate 10 and sealing the scraps 17. An experiment was performed by using a multi-layer film made of polycarbonate and indium oxide and having a thickness of about 120 μm as the film substrate 10. A hole 16 with a diameter of about 0.5 mm was formed in the film substrate 10 and a part of the film substrate 10 around the hole 16 was heated with a laser beam to seal scraps 17 generated around the hole 16. In this experiment, the film substrate 10 was placed above the focal point Fo of the condenser lens 20, the distance between the condenser lens 20 and the film substrate 10 was set at 9 mm, the distance between the film substrate 10 and the reflecting plate 21 was set at 6.5 mm, and the laser beam was emitted at an output level of 5 W for an illumination time of 1 s. As a result, the scraps 17 (burrs and fragments) on the inner surface of the hole 16 were effectively sealed in the fused part of the film substrate 10.

Since the melting point of polycarbonate is about 250° C. and the melting point of indium oxide is about 160° C., only the indium oxide layer of the multi-layer film may be fused at about 160° C. so that the polycarbonate layer is covered by the fused indium oxide layer.

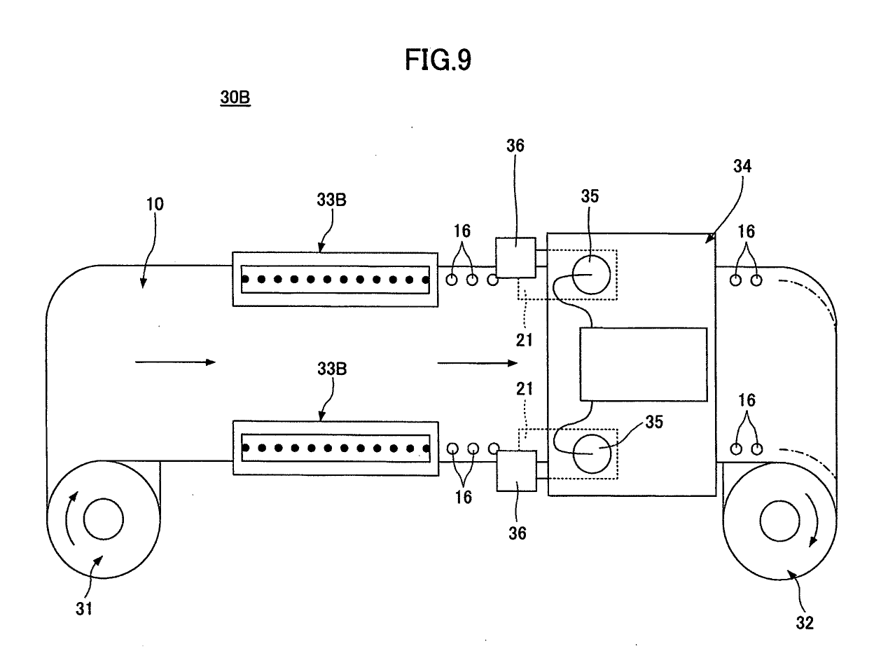

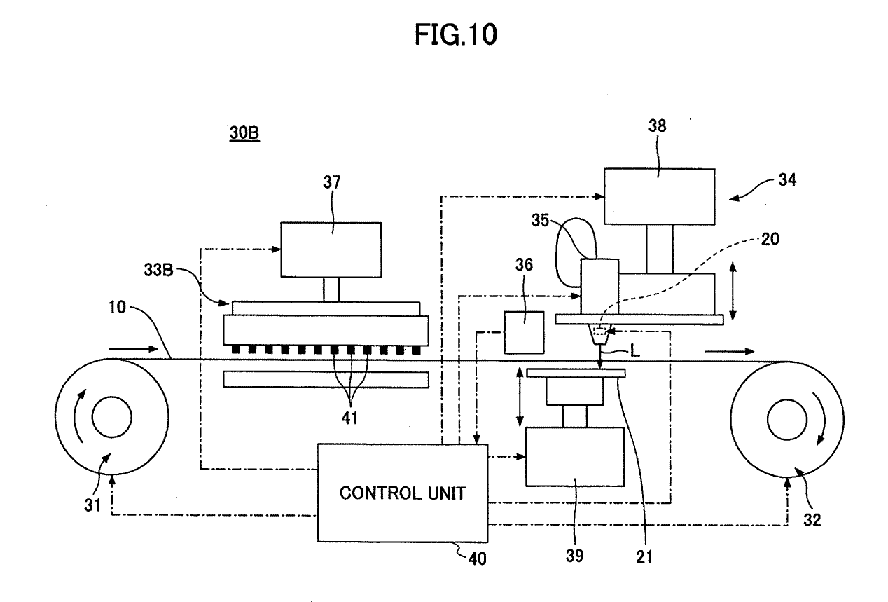

FIGS. 9 and 10 are diagrams illustrating a film substrate processing apparatus 30B that is a variation of the film substrate processing apparatus 30A illustrated by FIGS. 6 and 7. The same reference numbers as those in FIGS. 6 and 7 are assigned to the corresponding components in FIGS. 9 and 10, and the descriptions of those components are omitted here.

Each of the punching units 33A of the film substrate processing apparatus 30A illustrated in FIGS. 6 and 7 includes one punching die 41 for forming the hole 16. Meanwhile, a multi-hole punching unit 33B of the film substrate processing apparatus 30B includes multiple punching dies 41 and is configured to form multiple holes 16 at once.

This configuration makes it possible to more efficiently form the holes 16. In this variation, the film substrate processing apparatus 30B may include a hole sensor for detecting the holes 16 and the laser unit 35 (or the control unit 40) may be configured to emit the laser beam L based on the detection result from the hole sensor, i.e., when each of the holes 16 passes directly under the laser unit 35.

As described above, the embodiments of the present invention provide a film substrate processing method and a film substrate processing apparatus that make it possible to reliably prevent scraps generated around a removed portion of a film substrate from falling off or being scattered.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A method of processing a film substrate, the method comprising:
removing a portion of the film substrate; and
fusing a part of the film substrate around the removed portion to seal scraps of the film substrate, which are generated when removing the portion of the film substrate, in the fused part of the film substrate.

2. The method as claimed in claim 1, wherein the part of the film substrate is fused using a laser beam.

3. The method as claimed in claim 2, wherein fusing the part of the film substrate includes
illuminating a first surface of the film substrate with a direct beam of the laser beam; and
illuminating a second surface of the film substrate with a reflected beam that is the laser beam reflected by a reflecting plate disposed to face the second surface of the film substrate.

4. The method as claimed in claim 3, further comprising:
adjusting a distance between the film substrate and a condenser lens disposed to face the first surface of the film substrate and configured to focus the laser beam and thereby controlling an illumination condition of the direct beam on the first surface of the film substrate; and
adjusting a distance between the film substrate and the reflecting plate and thereby controlling an illumination condition of the reflected beam on the second surface of the film substrate.

5. The method as claimed in claim 4, wherein the distance between the film substrate and the condenser lens and the distance between the film substrate and the reflecting plate are adjusted such that a diameter of the direct beam on the first surface of the film substrate equals a diameter of the reflected beam on the second surface of the film substrate.

6. The method as claimed in claim 1, wherein removing the portion of the film substrate is cutting the portion of the film substrate.

7. The method as claimed in claim 1, wherein the scraps are burrs or fragments of the film substrate generated around the removed portion of the film substrate.

8. An apparatus for processing a film substrate, the apparatus comprising:
a removing unit configured to remove a portion of the film substrate;
a heating unit configured to fuse a part of the film substrate around the removed portion to seal scraps of the film substrate, which are generated when removing the portion of the film substrate, in the fused part of the film substrate; and
a feeding unit configured to feed the film substrate from the removing unit to the heating unit.

9. The apparatus as claimed in claim 8, wherein the heating unit includes
a laser unit configured to emit a laser beam;
a condenser lens disposed between the laser unit and the film substrate so as to face a first surface of the film substrate at a position corresponding to the removed portion of the film substrate and configured to focus the laser beam emitted by the laser unit; and
a reflecting plate disposed to face a second surface of the film substrate at a position corresponding to the removed portion of the film substrate and configured to reflect the laser beam.

10. The apparatus as claimed in claim 9, further comprising:
a height detection unit configured to detect a change in a height of the film substrate being fed from the removing unit to the heating unit;
a first lifting-and-lowering unit configured to move the condenser lens upward and downward;
a second lifting-and-lowering unit configured to move the reflecting plate upward and downward; and
a control unit configured to drive the first lifting-and-lowering unit and the second lifting-and-lowering unit based on the detected change in the height of the film substrate such that a diameter of a direct beam of the laser beam on the first surface of the film substrate equals a diameter of the reflected laser beam on the second surface of the film substrate.

11. The apparatus as claimed in claim 8, wherein the removing unit is configured to cut the portion of the film substrate.

12. The apparatus as claimed in claim 8, wherein the scraps are burrs or fragments of the film substrate generated around the removed portion of the film substrate.
